(19) United States
(12) Patent Application Publication
(10) Pub. No.: US 2014/0284937 A1
(43) Pub. Date: Sep. 25, 2014

(54) VIBRATION ENERGY HARVESTER

(71) Applicant: Oscilla Power Inc., Salt Lake City, UT (US)

(72) Inventors: James H. Dudley, Spring, TX (US); Jesse A. Nachlas, Salt Lake City, UT (US)

(73) Assignee: Oscilla Power Inc., Salt Lake City, UT (US)

(21) Appl. No.: 14/221,166

(22) Filed: Mar. 20, 2014

Related U.S. Application Data
(60) Provisional application No. 61/803,787, filed on Mar. 20, 2013.

(51) Int. Cl. H02K 7/18; E21B 4/00

(52) U.S. Cl. CPC H02K 7/1876; E21B 4/003
USPC 290/1 R; 384/10

(57) ABSTRACT

The system is a drilling bearing device. The device includes an outer body structure, and inner body structure, and a loading structure. The inner body structure is disposed at least partially within the outer body structure. The inner body structure moves relative to the outer body structure. The loading structure is disposed between the outer body structure and the inner body structure. The loading structure facilitates adjustment of a position of the inner body structure relative to the outer body structure relative to the outer body structure resulting from mechanical wear in the device. The loading structure substantially prevents displacement of the inner body structure relative to the outer body structure in response to a reciprocating displacement to maintain a substantially constant relative location.

### CROSS-REFERENCE TO RELATED APPLICATIONS

This application claims the benefit of U.S. Provisional Application No. 61/803,787, filed on Mar. 20, 2013, which is incorporated by reference herein in its entirety.

### STATEMENT OF FEDERALLY SPONSORED RESEARCH

This invention was made with Government support under IIP-1127503 awarded by the National Science Foundation. The Government has certain rights to this invention.

### BACKGROUND

As technology progresses, so does the need for electrical power. Some approaches to providing electrical power include advances in battery technology and power generation. Some conventional systems are mobile or are operated at remote sites where they cannot readily be installed and used in the vicinity of an easily accessible power source. However, many of these remote and isolated systems would benefit from or require power.

### SUMMARY

Embodiments of a device are described. In one embodiment, the system is a drilling bearing device. The device includes an outer body structure, and inner body structure, and a loading structure. The inner body structure is disposed at least partially within the outer body structure. The inner body structure moves relative to the outer body structure. The loading structure is disposed between the outer body structure and the inner body structure. The loading structure facilitates adjustment of a position of the inner body structure relative to the outer body structure relative to the outer body structure resulting from mechanical wear in the device. The loading structure substantially prevents displacement of the inner body structure relative to the outer body structure in response to a reciprocating displacement to maintain a substantially constant relative location. Other embodiments of the device are also described.

Embodiments of a system are also described. In one embodiment, the apparatus is an energy harvester system. The system includes a body portion, a loading structure, and a magnetostrictive element. The body portion has a unidirectional displacement and a reciprocating displacement. The loading structure is coupled to the body portion. The loading structure facilitates relative movement within the body portion to compensate for the unidirectional displacement. The loading structure further maintains the reciprocating displacement substantially constant through the body portion. The magnetostrictive element undergoes a change in mechanical stress in response to the reciprocating displacement. The change in mechanical stress in the magnetostrictive element generates an electric current in a conductor by induction. Other embodiments of the apparatus are also described.

Embodiments of a method are also described. In one embodiment, the method includes generating a unidirectional displacement. The method also includes generating a reciprocating displacement. A frequency of the reciprocating displacement is greater than a frequency of the unidirectional displacement. The method also includes communicating the unidirectional and reciprocating displacements to a body portion. The unidirectional displacement is counteracted and the reciprocating displacement is communicated to a magnetostrictive element. The reciprocating displacement causes a change in mechanical stress in the magnetostrictive element. The change in mechanical stress causes a change in a magnetic field at least partially surrounding the magnetostrictive element. The method also includes inducing a current in a conductor in response to the change in magnetic field at least partially surrounding the magnetostrictive element. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of a cross-sectional view of one embodiment of a system for vibration energy harvesting.

FIG. 2 depicts a flow chart diagram of one embodiment of a method.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments relate to vibration energy harvesting. In general, the invention employs magnetostrictive elements to derive power from mechanical displacement.

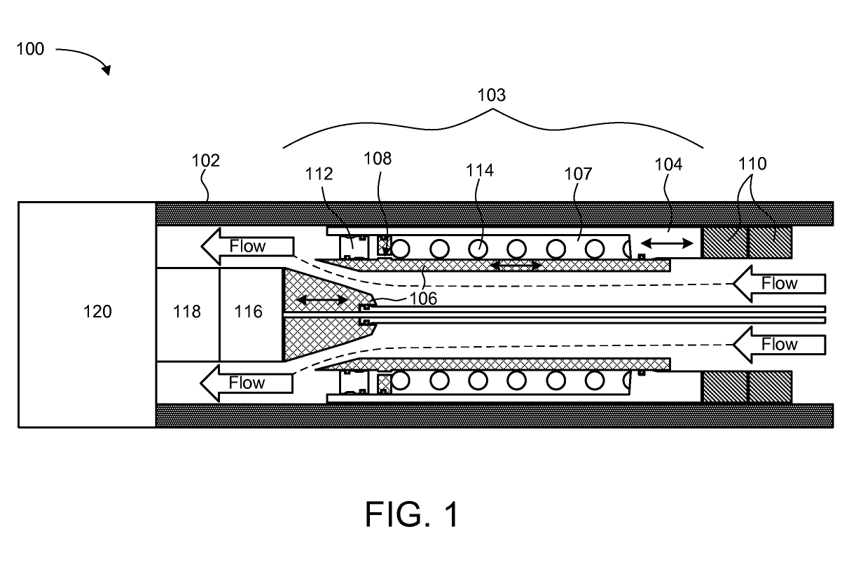

FIG. 1 depicts a schematic diagram of a cross-sectional view of one embodiment of a system 100 for vibration energy harvesting. The illustrated embodiment includes a housing 102, a body portion 103, a control point 108, jam nuts 110, a compensation piston 112, a spring element 114, electronics 116, an offset-sensitive device 118, and mud motor 120. Although the system 100 is shown and described with certain components and functionality, other embodiments of the system 100 may include fewer or more components to implement less or more functionality.

Generally, the system 100 is employed in a vibration or displacement intensive application. In many applications, it would be advantageous in one or more aspects to maintain a component in a specific location relative to another component through wear and displacement forces. This would provide benefits in many high-wear environments. For example, it may be used to measure dynamic displacement using an LVDT transducer while maintaining full range of motion. It may be used to position a transducer such as a magnetic proximity switch or an antenna or listening device. Additional applications may benefit from the invention described herein. One such application is down-hole drilling. In a drilling application, one embodiment of the invention is placed in the drilling line as a sealed bearing portion of the line. Vibration from drilling and operation of the mud motor can produce significant amounts of wear on the bearings in the drilling line. For example, joints, such as U-joints in the driveline, bearings in and surrounding the mud motor, generator (not shown), and other components can see significant wear and cause movement within a drilling assembly. Specific example of wear may occur in the thrust bearings of the mud motor and locations in the drilling assembly. Types of bearings that may be susceptible to wear may include sealed roller bearings, mud-lubricated marine bearings, and mud-lubricated PDC bearings. This can further increase wear and degrade control, efficiency, and quality of the drilling and drilling components. This wear can pose a multitude of problems during a drilling operation. For example, separation in the components adversely affects power generation through vibration harvesting. The described embodiments, adapt to the gradual separation caused by bearing and component wear through use of a hydraulic/spring system which creates movement in certain components to avoid separation. This allows the system to continue to generate power by harvesting substantially constant reciprocating displacement without disruption due to varying separation in the components.

In the illustrate embodiment of FIG. 1, the housing 102 encloses the body portion 103. In some embodiments, the housing 102 is a non-rotating component. In some embodiments, other components may be rotating or non-rotating. The body portion 103 includes an outer body structure 104 and an inner body structure 106. In the illustrated embodiment, the spring element 114 is placed between the outer and inner body structures 104 and 106 within the hydraulic chamber 107. In some embodiments, the spring element 114 is located in other portions of the system 100. The spring element 114 applies a force to cause a displacement of the outer body structure 104 relative to the inner body structure 106. In some embodiments, the spring element 114 moves the outer body structure 104. In another embodiment, the spring element 114 moves the inner body structure 106. In other embodiments, the spring element 114 may move either or both of the inner body structure 106 and the outer body structure 104.

The hydraulic chamber 107 functions as a damper or dashpot for the system 100 in controlling relative motion of the components. The hydraulic chamber 107 includes a control point 108. In one embodiment, the control point 108 is a check valve. In another embodiment, the control point 108 is a lee jet or other small aperture. In other embodiments, the control point 108 is another fluid flow control structure. The control point 108 allows hydraulic fluid to flow from the hydraulic chamber 107. In one embodiment, the control point 108 allows fluid to flow in response to a relatively low frequency force input at the body portion 103. For example, a low frequency force may be less than 0.1 Hz. In some embodiments, the control point 108 allows fluid to flow from the hydraulic chamber 107 and substantially prevents the fluid from returning to the hydraulic chamber 107. In this manner, the control point 108 allows the body portion 103 to adjust to movement in the system 100 due to wear in the components. Conversely, the control point 108 restricts the flow of hydraulic fluid in response to a relatively high frequency force input at the body portion 103. For example, a high frequency force input may be greater than 0.1 Hz. In another embodiment, the low frequency force is less than 0.05 Hz and the high frequency force is greater than 0.5 Hz. In another embodiment, the low frequency force is much less than 0.05 Hz. For example, the low frequency force may be less than approximately 0.0002 Hz.

The control point 108 allows the body portion 103 to adjust to, absorb, or counteract low frequency displacements and pass along or communicate high frequency displacements. In another embodiment, the control point 108 allows hydraulic fluid to return to the hydraulic chamber 107 at the same or different rate at which it was allowed to exit the hydraulic chamber 107. In some embodiments, the control point 108 may restrict or allow flow in either direction in response to detection of a trigger condition. For example, the control point 108 may be activated in response to detection of a temperature, pressure, or vibration threshold. Fewer or more control points 108 may be incorporated into the system 100.

The control point 108 passes hydraulic fluid to the compensation piston 112. The compensation piston 112 is positioned at the opening to the control point 108. The compensation piston 112 receives the hydraulic fluid expelled through the control point 108 from the hydraulic chamber 107. In one embodiment, the compensation piston 112 facilitates compensation for thermal expansion/contraction, hydraulic pressure regulation, wear compensation, and/or loading control for the offset-sensitive device 118. In some embodiments, the offset-sensitive device 118 includes a displacement transducer, a magnetostrictive element, or other device sensitive to movement in the system 100 due to wear of a bearing or other component.

In some embodiments, the compensation piston 112 includes a valve to relieve excessive pressure in the hydraulic fluid. This allows for management of forces exerted on components of the system 100. In some embodiments, the compensation piston 112 applies a compressive or tensile preload to accommodate temperature changes, pressure changes, and/or wear in components of the drilling assembly.

In the illustrate embodiment, the jam nuts 110 are in contact with the outer body structure 104. In one embodiment, the jam nuts 110 are placed to prevent movement of the components within the system 100. In some embodiments, the jam nuts 110 may be omitted or placed at other locations within the system 100 or at other locations in the drilling assembly.

In the illustrated embodiment, the electronics 116 are located next to the inner body structure 106. In some embodiments, the electronics 116 include components for power regulation, energy storage, monitoring and control elements to condition the power, a microcontroller, memory, communication, recording, and/or sensors. Another embodiment of the electronics 116 may include a conductive coil or other conductor to generate current in response to the change in magnetic field of the magnetostrictive element in the offset-sensitive device 118. In some embodiments, the conductive coil is wrapped substantially around the magnetostrictive element. In some embodiments, the electronics 116 include multiple components. In other embodiments, a single component is included in the electronics 116.

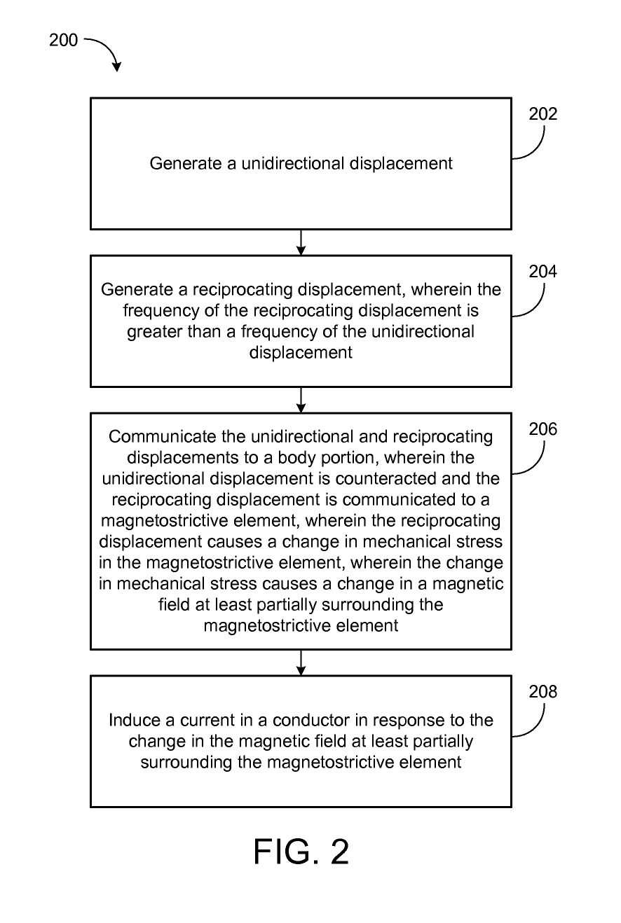

FIG. 2 depicts a flow chart diagram of one embodiment of a method 200. Although the method 200 is described in conjunction with the system 100 of FIG. 1, embodiments of the method 200 may be implemented with other types of systems.

At block 202, a unidirectional displacement is generated. At block 204, a reciprocating displacement is generated. The frequency of the reciprocating displacement is greater than a frequency of the unidirectional displacement. At block 206, the unidirectional and reciprocating displacements are communicated to the body portion 103. The unidirectional displacement is counteracted and the reciprocating displacement is communicated to the magnetostrictive element 118. The reciprocating displacement causes a change in mechanical stress in the magnetostrictive element 118. The change in mechanical stress causes a change in the magnetic field at least partially surrounding the magnetostrictive element 118. At block 208, a current in induced in a conductor in response to the change in the magnetic field at least partially surrounding the magnetostrictive element 118.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A drilling bearing device comprising:
an outer body structure;
an inner body structure disposed at least partially within the outer body structure, the inner body structure configured to move relative to the outer body structure; and
a loading structure disposed between the outer body structure and the inner body structure, the loading structure to facilitate adjustment of a position of the inner body structure relative to the outer body structure in response to a unidirectional displacement of the inner body structure relative to the outer body structure resulting from mechanical wear in the device, wherein the loading structure is configured to substantially prevent displacement of the inner body structure relative to the outer body structure in response to a reciprocating displacement to maintain a substantially constant relative location.

2. The device of claim 1, wherein the unidirectional displacement is due to at least one of a list of causes, the list comprising bearing wear, thermal expansion, and component erosion.

3. The device of claim 1, wherein adjustment of the position of the inner body structure relative to the outer body structure in response to the unidirectional displacement results in the reciprocating displacement having substantially constant load cycles.

4. The device of claim 1, wherein the loading structure comprises a hydraulic chamber with hydraulic fluid.

5. The device of claim 4, wherein the hydraulic chamber comprises a control point comprising a check valve configured to allow fluid flow in response to the unidirectional displacement and restrict fluid flow in response to reciprocating displacement.

6. The device of claim 4, wherein the hydraulic chamber comprises a control point comprising a lee jet configured to allow fluid flow in response to the unidirectional displacement and restrict fluid flow in response to reciprocating displacement.

7. The device of claim 4, wherein the hydraulic chamber comprises a control point comprising a hole configured to allow fluid flow in response to the unidirectional displacement and restrict fluid flow in response to reciprocating displacement.

8. The device of claim 1, wherein the loading structure comprises a spring element to apply a force to at least one of the inner body structure and the outer body structure to facilitate unidirectional motion of the inner body structure relative to the outer body structure.

9. The device of claim 1, further comprising an offset-sensitive device, wherein the relative motion of the inner body structure and the outer body structure by the loading structure substantially reduces a negative effect of the unidirectional displacement on the offset-sensitive device.

10. An energy harvester system comprising:
a body portion having a unidirectional displacement and a reciprocating displacement;
a loading structure coupled to the body portion, the loading structure configured to facilitate relative movement within the body portion to compensate for the unidirectional displacement, the loading structure further configured to maintain the reciprocating displacement substantially constant through the body portion; and
a magnetostrictive element configured to undergo a change in mechanical stress in response to the reciprocating displacement, wherein the change in mechanical stress in the magnetostrictive element generates an electric current in a conductor by induction.

11. The system of claim 10, wherein the loading structure comprises a hydraulic chamber with hydraulic fluid.

12. The system of claim 11, wherein the hydraulic chamber comprises a check valve control point configured to allow the hydraulic fluid to pass in response to the unidirectional displacement and restrict hydraulic fluid flow in response to the reciprocating displacement.

13. The system of claim 11, wherein the hydraulic chamber comprises a lee jet control point configured to allow the hydraulic fluid to pass in response to the unidirectional displacement and restrict hydraulic fluid flow in response to the reciprocating displacement.

14. The system of claim 10, wherein the loading structure comprises a spring element to apply a force within the loading structure, wherein the spring element facilitates movement within the body structure to compensate for the unidirectional displacement.

15. The system of claim 10, wherein the unidirectional displacement is due to at least one of a list of causes, the list comprising bearing wear, thermal expansion, and part erosion.

16. The system of claim 10, wherein adjustment of the position of the inner body structure relative to the outer body structure in response to the unidirectional displacement results in the reciprocating displacement having substantially constant load cycles.

17. A method for harvesting energy, the method comprising:
generating a unidirectional displacement;
generating a reciprocating displacement, wherein a frequency of the reciprocating displacement is greater than a frequency of the unidirectional displacement;
communicating the unidirectional and reciprocating displacements to a body portion, wherein the unidirectional displacement is counteracted and the reciprocating displacement is communicated to a magnetostrictive element, wherein the reciprocating displacement causes a change in mechanical stress in the magnetostrictive element, wherein the change in mechanical stress causes a change in a magnetic field at least partially surrounding the magnetostrictive element; and
inducing a current in a conductor in response to the change in the magnetic field at least partially surrounding the magnetostrictive element.

18. The method of claim 17, wherein the reciprocating displacement communicated to the magnetostrictive element comprises substantially constant load cycles.

19. The method of claim 17, wherein counteracting the unidirectional displacement comprises moving hydraulic fluid through a control point in a hydraulic chamber.

20. The method of claim 19, wherein the hydraulic chamber comprises a spring element to apply force to the hydraulic chamber to move the hydraulic fluid in response to the unidirectional displacement.
